(19) United States
(12) Patent Application Publication
(10) Pub. No.: US 2016/0078574 A1
(43) Pub. Date: Mar. 17, 2016

(54) VIRTUAL PROPERTY MANAGEMENT IN AN INTERACTIVE GEOGRAPHIC INFORMATION SYSTEM

(71) Applicant: Mark Sprague, Manhattan Beach, CA (US)

(72) Inventor: Mark Sprague, Manhattan Beach, CA (US)

(21) Appl. No.: 14/486,822

(22) Filed: Sep. 15, 2014

(51) Int. Cl. G06Q 50/16; G06T 17/05; G06Q 30/00; G06Q 30/02; G06Q 40/08

(52) U.S. Cl. CPC G06Q 50/163; G06Q 30/0269; G06Q 40/08; G06Q 30/0185; G06T 17/05

(57) ABSTRACT

The subject disclosure provides methods and systems for managing information provided in conjunction with a virtual property (“VP”), and in some aspects, for managing a title associated with the same. In some implementations, a method of the subject disclosure can include steps for receiving a virtual property claim, authenticating the virtual property claim to determine if the user is in possession of a rightful title of the parcel of real property, and granting access to a title policy for the virtual property asset if the virtual property claim is properly authenticated. In some aspects, systems and computer-readable media are also provided.

### BACKGROUND

1. Field of the Invention

The subject disclosure relates to a method for managing virtual property (VP), and in particular, to managing VP information in an interactive geographic information system (IGIS).

2. Introduction

With the increasing availability of online geographic information, including real-estate listings and real-property information, there is an increasing prevalence in the online marketing of real-property. In this regard, some online service providers, such as online map services, automatically aggregate and provide images and other information associated with real property, to any user with Internet access.

### SUMMARY

The disclosed subject matter relates to a computer-implemented method for managing a virtual property, the method including steps for receiving a virtual property claim, wherein the virtual property claim identifies a user's interest in a virtual property asset corresponding with a parcel of real property, authenticating, by the processor, the virtual property claim to determine if the user is in possession of a rightful title of the parcel of real property, granting access to a title policy for the virtual property asset if the virtual property claim is properly authenticated, and denying access to the title policy for the virtual property asset if the virtual property claim is not properly authenticated.

The disclosed subject matter also relates to a system for managing a virtual property, the system including one or more processors, and computer-readable medium including instructions stored therein, which when executed by the processors, cause the processors to perform operations including receiving a virtual property claim, wherein the virtual property claim identifies a user's interest in a virtual property asset corresponding with a parcel of real property, authenticating the virtual property claim to determine if the user is in possession of a rightful title of the parcel of real property, granting access to a title policy for the virtual property asset if the virtual property claim is properly authenticated, and denying access to the title policy for the virtual property asset if the virtual property claim is not properly authenticated.

The disclosed subject matter also relates to a computer-readable medium comprising instructions stored therein, which when executed by a processor, cause the processor to perform operations including, receiving a virtual property claim, wherein the virtual property claim identifies a user's interest in a virtual property asset corresponding with a parcel of real property, authenticating the virtual property claim to determine if the user is in possession of a rightful title of the parcel of real property, granting access to a title policy for the virtual property asset if the virtual property claim is properly authenticated, and denying access to the title policy for the virtual property asset if the virtual property claim is not properly authenticated.

It will be understood that other configurations will become apparent to those skilled in the art from the following detailed description, wherein various configurations are shown and described by way of illustration. As will be appreciated, the present disclosure is capable of other and different configurations and its several details are capable of modification in various other respects, all without departing from the scope thereof. Accordingly, the drawings and detailed description are to be regarded as illustrative, and not restrictive in nature.

### BRIEF DESCRIPTION OF THE DRAWINGS

Certain features of the present disclosure are set forth in the appended claims. However, the accompanying drawings, which are included to provide further understanding, illustrate disclosed aspects and together with the description hereof, serve to explain the principles of the subject disclosure. In the drawings:

FIG. 1 illustrates an example network device that can be used to implement an interactive geographic information system (IGIS), according to certain aspects of the subject disclosure.

FIG. 2 illustrates an example network system that can be used to implement aspects of the disclosed embodiment.

FIG. 3 conceptually illustrates a block diagram of steps for implementing a virtual property management method, according to some aspects of the disclosed embodiment.

### DETAILED DESCRIPTION

The detailed description set forth below is intended as a description of various configurations of the subject disclosure and is not intended to represent the only configurations in which the technology can be practiced. The appended drawings are incorporated herein and constitute a part of the detailed description. The detailed description includes specific details for the purpose of providing a more thorough understanding of the technology. However, it will be clear and apparent that the technology is not limited to the specific details set forth herein and may be practiced without these specific details. In some instances, structures and components are shown in block diagram form in order to avoid obscuring concepts of the technology.

Online services that aggregate and provide geographic and real-estate information often do so without the consent or involvement of owner/s and/or manager/s of the corresponding real property. For example, a business owner's building may be depicted by an online map or real estate listing, without providing management authority (e.g., over the type and manner in which associated information is displayed) to the owner. There are myriad reasons why an owner of real property would have an interest in maintaining control over the type of information and/or aesthetic display associated with an online rendering of their real property or real estate. By way of example, an owner may wish to control a three-dimensional (3-D) rendering of a house that he/she wishes to list for sale, much in the same way that a potential seller/home-owner is concerned with a showing or advertisement of real-property offered for sale.

In certain aspects, control or management authority over an online “virtual property” (VP), that represents a corresponding real-property parcel or estate, can be considered as a separate title or right that is part of an owner's bundle of rights.

The subject disclosure provides methods and systems for associating owners of real property or real estate, with a corresponding virtual property title. As discussed in further detail below, aspects of the technology encompass ways in which a VP title can be awarded or conveyed to a user, for example, based on his/her demonstration of ownership over a corresponding piece of real-estate or real-property.

With possession over VP title or “virtual title,” an owner can control various aspects relating to associated information and display in an online environment. In some implementations, user control over attributes of a VP can be managed by a networked information system, such as an interactive geographic information system (IGIS). As discussed further below, user management rights awarded with a virtual title can encompass attributes of 3-D renderings of a VP in the IGIS, as well as advertisements, information and/or statistics presented in conjunction with the VP, for example, in a virtual rendering or “virtual world.”

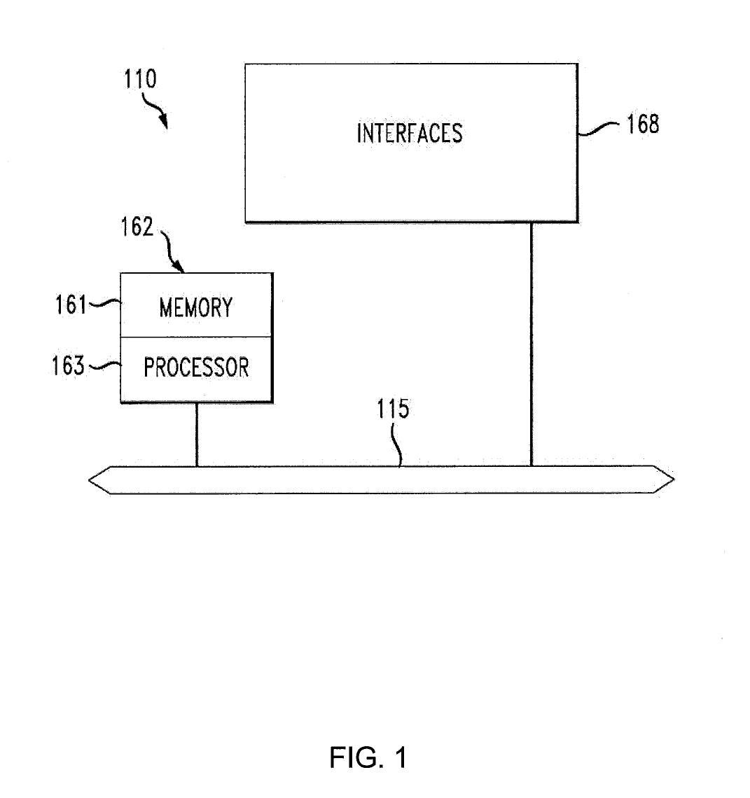

A brief introductory description of example systems and networks, as illustrated in FIG. 1, is disclosed herein. FIG. 1 illustrates an example network device 110 suitable for implementing an IGIS system of the present invention. Network device 110 includes a master central processing unit (CPU) 162, interfaces 168, and bus 115 (e.g., a PCI bus). When acting under the control of appropriate software or firmware, CPU 162 is responsible for executing access control operations, packet management, error detection, and/or routing functions. CPU 162 can accomplish all these functions under the control of software including an operating system and any appropriate applications software, such as 3-D rendering software used to display 3-D models of virtual assets in a virtual environment. In alternative aspects, processor 163 can be specially designed hardware for controlling the operations of network device 110. In a specific implementation, memory 161 (such as non-volatile RAM and/or ROM) also forms part of CPU 162. However, there are many different ways in which memory 161 may be coupled to the system.

Interfaces 168 are typically provided as interface cards (sometimes referred to as “line cards”). Generally, they control the sending and receiving of data packets over the network and sometimes support other peripherals used with network device 110. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like.

In this manner, IGIS system 110 can collaboratively interface with various other processor-based network devices, for example, that are used to support a virtual environment or online database in which VPs are accessible to online users.

Although the system shown in FIG. 1 is one specific network device of the present invention, it is not the only network device architecture on which aspects of the subject disclosure can be implemented. For example, an architecture having a single processor that handles communications as well as routing computations, etc. is often used. Further, other types of interfaces and media may also be implemented.

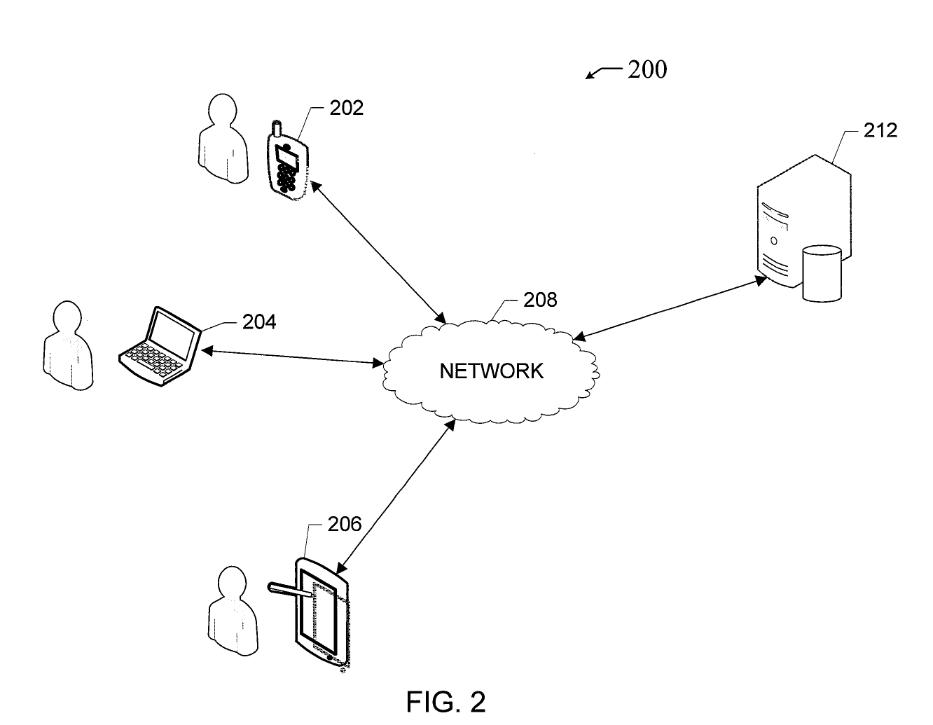

FIG.2 illustrates an example network system that can be used for implementing an IGIS server 212 to manage titles for one or more virtual properties, according to some aspects of the technology. Specifically, network system 200 includes user devices cellphone 202, computer 204, and tablet 206 and IGIS server 212. In the illustrated configuration, each of user devices 202, 204, and 206 is communicatively coupled to IGIS server 212, via network 208.

It is understood that in addition to user devices 202, 204, 206 and IGIS server 212, any number of other processor-based devices may be communicatively connected to network 208. Furthermore, as discussed in greater detail below, network 208 can include multiple networks, such as a network of networks, e.g., the Internet. Similarly, IGIS server 212 may be implemented using one or more other processor-based network device/s or server/s, depending on implementation.

In some examples, one or more of the process steps of the subject disclosure can be carried out by one or more of user device/s 202, 204 and/or 206, e.g., using IGIS server 212 and network 208. By way of example, a user associated with user device 204 can be the owner of a real-estate parcel associated with a virtual property (VP) maintained on IGIS server 212. Thus, the user of user device 204 may wish to possess, or gain access to a virtual title, enabling him/her to manage the display of the VP to one or more other users (e.g., those associated with user devices 202 and/or 206) over IGIS server 212.

In some aspects, the user of user device 204 may authenticate ownership of a real-estate parcel associated with a VP maintained by IGIS server 212. For example, geocodes, information from local land registries, and/or title information for the corresponding real-estate parcel may be used to demonstrate ownership by the user of user device 204, resulting in access/ownership of the corresponding virtual title.

Control over a virtual title (e.g., for VP) can yield different rights for the owner, depending on implementation. For example, virtual title can enable the user/owner to control a display of information such as, but not limited to: geocode information, geolocation information, property/building dimensions, square footage, and/or a number of bedrooms or bathrooms, etc. In other aspects, possession or control of a virtual title can enable a user to control the display of images or 3-D models for a particular property or parcel.

In some implementations, IGIS server 212 can also function to store and/or maintain virtual property insurance policy information, e.g., for a VP. Thus, in some aspects, IGIS server 212 can also facilitate the management, as well as transfer (e.g., sale/purchase) of a virtual property or an associated virtual title insurance policy associated with the same.

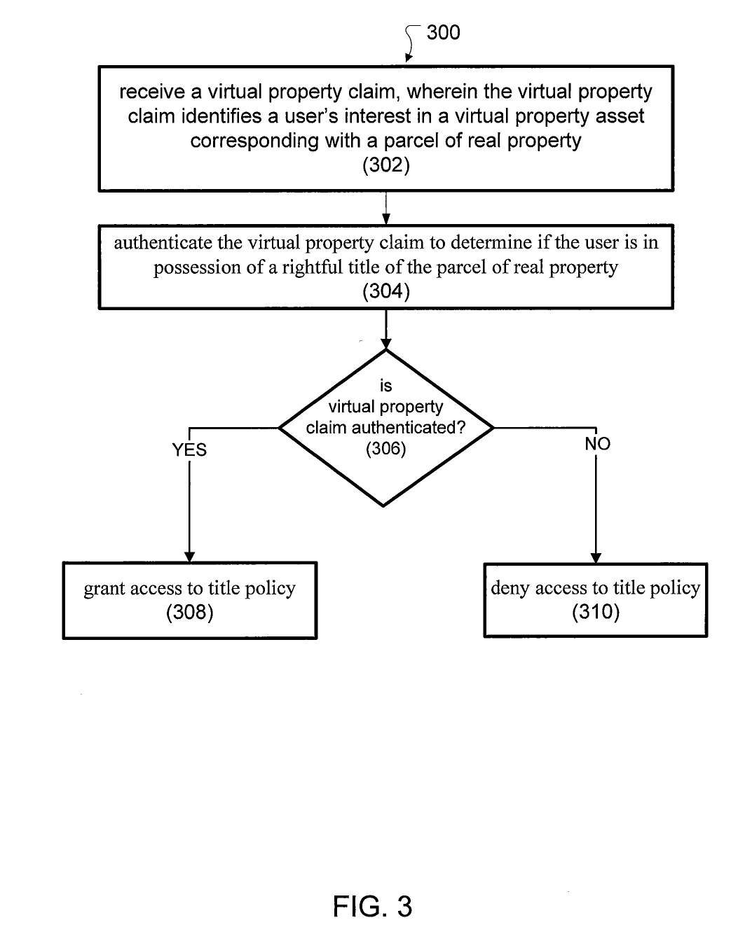

FIG. 3 conceptually illustrates a block diagram of steps for implementing a virtual property management method 300, according to some aspects of the technology. Method 300 begins with step 302, in which a virtual property claim is received (e.g., by an IGIS system), and wherein the virtual property claim identifies a user's interest in a virtual property asset corresponding with a parcel of real property.

It will be understood that the virtual property claim may include different types of identifying user information. For example, the virtual property claim can include any information identifying user's interest in, or ownership of, a real property asset for which the IGIS is used to manage a virtual title. By way of example, the virtual property claim can include information identifying a real-property title, geolocation information, and/or deed information for a corresponding parcel of real property.

Once the virtual property claim is received, method 300 proceeds to step 302 wherein the virtual property claim is authenticated to determine if the user is in possession of a rightful title of the parcel of real property (e.g., that is associated with the requested virtual title for a corresponding VP).

Subsequently, in decision step 306, it is determined if the virtual property claim is authenticated. If the claim can be authenticated, method 300 proceeds to step 308, wherein access to a corresponding virtual property title is permitted to the user. Alternatively, if in decision step 306 the virtual property claim is not authenticated, method 300 proceeds to step 310, wherein access to the title policy is denied.

Access to the title policy may confer various rights and privileges to the user, as discussed above. For example, ownership of a virtual title policy can enable the user to determine the types of information for a VP that are accessible to other users, e.g., via IGIS server 212, as discussed above. Additionally, in some aspects, control of a virtual title policy may confer rights to a virtual title insurance policy for the subject VP.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD−RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject disclosure or that such aspect applies to all configurations of the subject disclosure. A disclosure relating to an aspect may apply to all configurations, or one or more configurations. A phrase such as an aspect may refer to one or more aspects and vice versa. A phrase such as a “configuration” does not imply that such configuration is essential to the subject disclosure or that such configuration applies to all configurations of the subject disclosure. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for managing a virtual property, the method comprising:
receiving, by a processor, a virtual property claim, wherein the virtual property claim identifies a user's interest in a virtual property asset corresponding with a parcel of real property;
authenticating, by the processor, the virtual property claim to determine if the user is in possession of a rightful title of the parcel of real property;
granting access to a title policy for the virtual property asset if the virtual property claim is properly authenticated; and
denying access to the title policy for the virtual property asset if the virtual property claim is not properly authenticated.

2. The computer-implemented method of claim 1, wherein access to the title policy is configured to allow a user to control a display of the virtual property asset in an interactive geographic information system (IGIS).

3. The computer-implemented method of claim 1, wherein access to the title policy is configured to enable a user to determine one or more types of information pertaining to the virtual property asset that are available to one or more other users in an interactive geographic information system (IGIS).

4. The computer-implemented method of claim 1, wherein access to the title policy is configured to enable the user to determine whether one or more advertisements are displayed in conjunction with the virtual property asset in an interactive geographic information system (IGIS).

5. The computer-implemented method of claim 1, wherein access to the title policy is configured to enable the user to control a three-dimensional (3D) display of the virtual property asset an interactive geographic information system (IGIS).

6. The computer-implemented method of claim 1, wherein the virtual property claim comprises one or more geocodes identifying the parcel of real property corresponding with the virtual property.

7. The computer-implemented method of claim 1, further comprising:
providing virtual title insurance for the virtual property in response to a determination that the virtual property claim is properly authenticated.

8. A system for managing a virtual property, the system comprising:
one or more processors; and
a computer-readable medium comprising instructions stored therein, which when executed by the processors, cause the processors to perform operations comprising:
receiving a virtual property claim, wherein the virtual property claim identifies a user's interest in a virtual property asset corresponding with a parcel of real property;
authenticating the virtual property claim to determine if the user is in possession of a rightful title of the parcel of real property;
granting access to a title policy for the virtual property asset if the virtual property claim is properly authenticated; and
denying access to the title policy for the virtual property asset if the virtual property claim is not properly authenticated.

9. The system of claim 8, wherein access to the title policy enables the user to control a display of the virtual property asset in an interactive geographic information system (IGIS).

10. The system of claim 8, wherein access to the title policy enables the user to determine one or more types of information pertaining to the virtual property asset that are available to one or more other users in an interactive geographic information system (IGIS).

11. The system of claim 8, wherein access to the title policy enables the user to determine whether one or more advertisements are displayed in conjunction with the virtual property asset in an interactive geographic information system (IGIS).

12. The system of claim 8, wherein access to the title policy enables the user to control a three-dimensional (3D) display of the virtual property asset an interactive geographic information system (IGIS).

13. The system of claim 8, wherein the virtual property claim comprises one or more geocodes identifying the parcel of real property corresponding with the virtual property.

14. The system of claim 8, wherein the processors are further configured to perform operations comprising:
providing virtual title insurance for the virtual property in response to a determination that the virtual property claim is properly authenticated.

15. A computer-readable storage medium comprising instructions stored therein, which when executed by one or more processors, cause the one or more processors to perform operations comprising:
receiving, by a processor, a virtual property claim, wherein the virtual property claim identifies a user's interest in a virtual property asset corresponding with a parcel of real property;
authenticating, by the processor, the virtual property claim to determine if the user is in possession of a rightful title of the parcel of real property;
granting access to a title policy for the virtual property asset if the virtual property claim is properly authenticated; and
denying access to the title policy for the virtual property asset if the virtual property claim is not properly authenticated.

16. The computer-readable storage medium of claim 15, wherein access to the title policy enables the user to control a display of the virtual property asset in an interactive geographic information system (IGIS).

17. The computer-readable storage medium of claim 15, wherein access to the title policy is configured to enable the user to determine one or more types of information pertaining to the virtual property asset that are available to one or more other users in an interactive geographic information system (IGIS).

18. The computer-readable storage medium of claim 15, wherein access to the title policy is configured to enable the user to determine whether one or more advertisements are displayed in conjunction with the virtual property asset in an interactive geographic information system (IGIS).

19. The computer-readable storage medium of claim 15, wherein access to the title policy is configured to enable the user to control a three-dimensional (3D) display of the virtual property asset an interactive geographic information system (IGIS).

20. The computer-readable storage medium of claim 15, wherein the virtual property claim comprises one or more geocodes identifying the parcel of real property corresponding with the virtual property.
